(19) United States
(12) Patent Application Publication
(10) Pub. No.: US 2010/0230262 A1
(43) Pub. Date: Sep. 16, 2010

(54) PANEL MOUNT SEALED PUSHBUTTON SWITCH

(76) Inventor: PATRICK J. DEVINE, NASHUA, NH (US)

Correspondence Address: PEARSON & PEARSON, LLP, 10 GEORGE STREET, LOWELL, MA, 01852, US

(21) Appl. No.: 12/401,246

(22) Filed: Mar. 10, 2009

(51) Int. Cl. H01H 13/06; H01H 11/00

(52) U.S. Cl. 200/302.2; 29/622

(57) ABSTRACT

A fully sealed, low cost pushbutton switch for mounting in a panel without use of a tool comprising a single pole double throw switch enclosed within a boot/gasket housing. Two wire leads are attached to terminals on the push button switch in a cavity area which is filled with an epoxy, and a base cover forms and seals a lower surface of the terminal cavity areas.

### BACKGROUND OF THE INVENTION

1. Field of the Invention

This invention relates generally to a low cost pushbutton switch and, in particular, to a fully sealed pushbutton switch that results in a tool-free mounting of the switch in a panel of an end product.

2. Description of Related Art

There are many pushbutton switches that are compact and reliable, but in some applications it is necessary to have a sealed switch assembly, especially in an outside environment where the switch is susceptible to rain, moisture, debris, etc., that is fully sealed and installed in an application panel without a tool. Most push button switches require the addition of a boot or other sealing method that must be purchased in addition to the base switch. Sealing of the switch behind the panel must be performed after installation as a secondary operation.

U.S. Pat. No. 2,950,373 issued Aug. 23, 1960 to Philip D. Grover et al. discloses a device for rendering a switch environment-resistant having a casing from which an operating button projects through an outwardly projecting collar comprising a metallic bushing fixed to the casing and collar and encircling the button, a flexible diaphragm fixed in the brushing, and a plunger fixed in the diaphragm extending outwardly and inwardly and into engagement with the button. However, this device requires additional adhesives for panel sealing, additional hardware for installation, additional housing to seal rear of switch, and the housing prohibits panel mounting.

U.S. Pat. No. 3,316,379 issued Apr. 25, 1967, to D. E. Clarke et al. discloses a fluid-tight seal for a pushbutton activated electrical switch to protect the interior switch parts. A sealing enclosure is mounted on a bushing and the sealing enclosure surrounds the pushbutton. However, a threaded nut must be tightened on mounted switch. The boot can be unscrewed and removed by hand, there is no option for sealing the rear of the switch, and the boot must be purchased as a separate item at an additional cost.

U.S. Pat. No. 5,389,758 issued Feb. 14, 1995 to William J. Agnatovech discloses a miniature pushbutton switch which includes respective assemblies each of plastic molded construction which are configured to be snap fitted together for final assembly of the switch. A flexible tubular boot manufactured of rubber or the like has a first end inserted into an annular groove on a shaft portion of the pushbutton activator and a second end of the boot is disposed over a raised collar of the switch to prevent introduction of foreign matter into the switch. However, this pushbutton switch requires an additional external boot for sealing the switch, the boot does not seal at the panel, and the rear of switch is not sealed.

U.S. Pat. No. 5,898,147 issued Apr. 27, 1999 to Frank Domzalski et al. discloses a sealed, dual tack switch assembly providing tactile feel. However, it does not mount on a panel, but instead it is designed to mount on an electronic PC board. Further, there is no panel seal and no seal at rear of the pushbutton switch.

U.S. Pat. No. 6,768,070 issued Jul. 27, 2004 to John Lewison et al. discloses a switch comprising a body which includes an external groove (42) for mounting the switch on a panel, and a seal is provided in the external groove to prevent the ingress of water to the recess of the body. However, a printed circuit board mounts to the body of the switch to define a closed switch cavity, but in the present invention the switch is complete by itself. Further, this switch requires a secondary operation to seal the rear of the switch after assembly in a panel.

### SUMMARY OF THE INVENTION

Accordingly, it is therefore an object of this invention to provide a low cost fully sealed single pole double throw pushbutton switch assembly that requires no tools for mounting in a panel application.

It is another object of the invention to provide two lead wires for attaching to terminals of the pushbutton switch for connecting the switch assembly to a circuit.

It is a further object of this invention to provide an epoxy within a cavity in the lower end of the pushbutton switch assembly having a base cover to form the lower surface of the cavity and the pushbutton switch assembly.

It is yet another object of this invention to provide a method for assembling a fully sealed switch assembly comprising the step of enclosing a single pole double throw pushbutton switch within a preformed flexible boot, this boot having an inner cylindrical post for contacting the top of the pushbutton switch causing the switch to activate when pushed.

These and other objects are further accomplished by providing a low cost switch assembly comprising of a pushbutton switch, a sealing boot for receiving the pushbutton switch, the sealing boot comprises an upper section for contacting a button portion of the switch and a lower section for receiving a base portion of the switch, at least two wire leads each attached to a separate terminal of the pushbutton switch, and a base cover secured to the lower section of the sealing base. The switch assembly comprises a terminal cavity between the terminals of the pushbutton switch, and the base cover, the terminal cavity being filled with an epoxy for sealing the switch assembly. The pushbutton switch comprises a single pole double throw switch. The upper section of the sealing boot comprises a post for contacting the button portion of the pushbutton switch for activating the switch when the upper section of the boot is pushed inward. The sealing boot comprises a groove surrounding an outside of the sealing boot for mounting the switch assembly in an application panel without a tool.

The objects are further accomplished by providing a method of making a low cost switch assembly comprising the steps of providing a pushbutton switch, inserting the pushbutton switch within a sealing boot, wherein a button portion of the switch enters an upper section of the sealing boot and a base portion of the switch is enclosed within a lower section of the sealing boot, attaching each of at least two lead wires to a separate terminal of the pushbutton switch, and securing a base cover to the lower section of the sealing boot. The method comprises the steps of providing a terminal cavity between the terminals of the pushbutton switch and the base cover, and filling the terminal cavity with an epoxy for sealing the switch assembly. The step of providing a pushbutton switch comprises the step of providing a single pole double throw pushbutton switch. The step of inserting the pushbutton switch within a sealing boot comprises the step of providing a post on the inside of the sealing boot extending toward the button portion of the pushbutton switch to activate the switch when the upper section of the sealing boot is pushed inward. The step of inserting the pushbutton switch within a sealing boot comprises the step of providing a groove around an outside perimeter of the sealing boot for mounting the switch assembly in an application panel without use of a tool.

Additional objects, features and advantages of the invention will become apparent to those skilled in the art upon consideration of the following detailed description of the preferred embodiments exemplifying the best mode of carrying out the invention as presently perceived.

### BRIEF DESCRIPTION OF THE DRAWINGS

The appended claims particularly point out and distinctly claim the subject matter of this invention. The various objects, advantages and novel features of this invention will be more fully apparent from a reading of the following detailed description in conjunction with the accompanying drawings in which like reference numerals refer to like parts, and in which:

FIG. 1 is an exploded perspective view of a fully sealed pushbutton switch assembly according to the invention.

FIG. 2 is an inverted exploded perspective view of the fully sealed pushbutton switch assembly prior to applying epoxy encapsulate.

FIG. 3 is a perspective view of a fully sealed pushbutton switch assembly installed in a panel without use of a tool according to the invention.

FIG. 4 is a front elevational view of the sealed pushbutton switch assembly.

FIG. 5 is a cross-sectional view of an upper portion of a sealing boot of the sealed pushbutton switch assembly along lines 5-5 in FIG. 4 showing a cylindrical post extending downward from a top inside surface.

### DESCRIPTION OF ILLUSTRATIVE EMBODIMENT

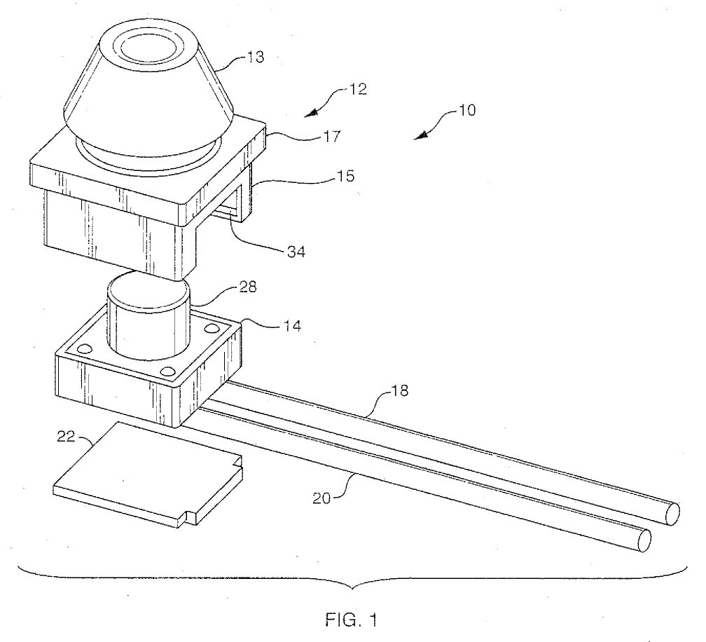

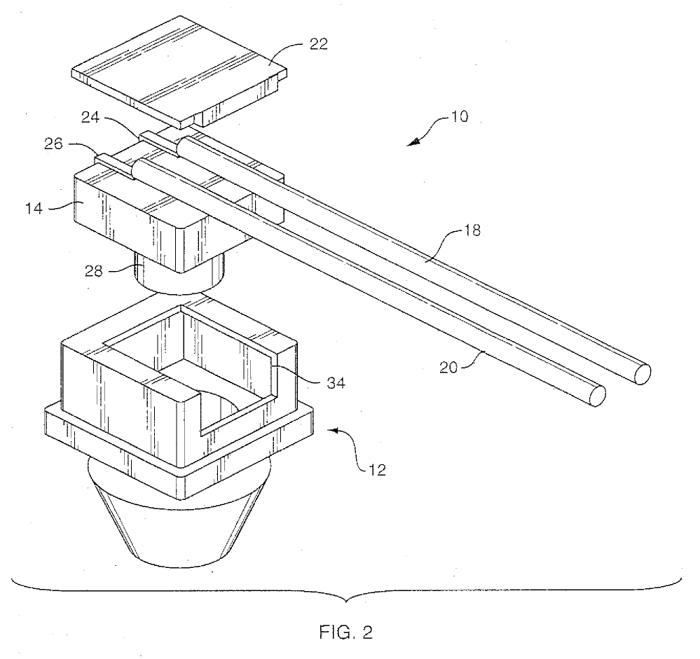

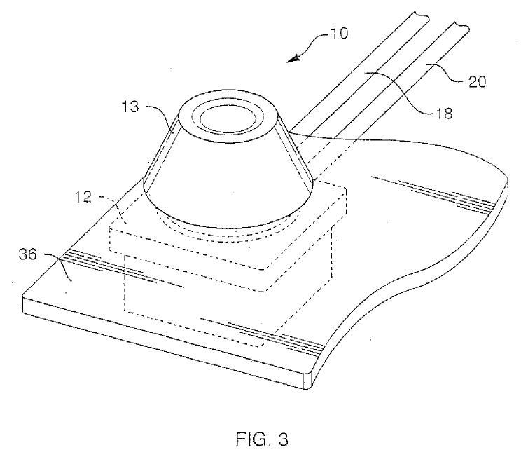

Referring to FIG. 1 and FIG. 2, FIG. 1 shows an exploded perspective view of a fully sealed pushbutton switch assembly 10 according to the present invention. FIG. 2 is an inverted exploded perspective view of the fully sealed pushbutton switch assembly 10 prior to applying an epoxy encapsulate in a terminal cavity 19 (FIG. 3). The pushbutton switch assembly 10 comprises a sealing boot 12, a single pole double throw pushbutton switch 14 with tactile feel having two terminals 24, 26, two wire leads 18, 20 attached to the terminals 24, 26 respectively by soldering or welding and a base cover 22.

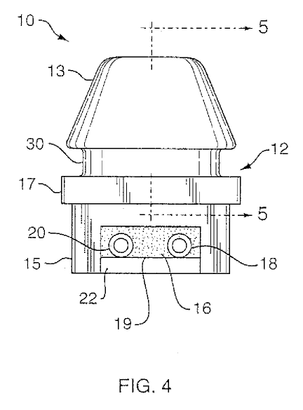

Referring to FIG. 3, and FIG. 4, FIG. 3 is a perspective view of the fully sealed pushbutton switch assembly 10 shown mounted in a panel 36 and requiring no tools for such mounting. FIG. 4 is a front elevational view of the switch assembly 10 showing a groove 30 around the switch assembly 10 for panel mounting. The sealing boot 12 comprises a mushroom-shaped upper section 13, and a base section 15 having an upper overhang portion 17 as section 13 is approximately 23 degrees from vertical and the height is approximately 0.3 inches in the preferred embodiment. The overall height of the switch assembly is approximately 0.73 inches. The groove 30 is formed between the bottom of the mushroom-shaped upper section 13 and the overhang portion 17 of the base section 15. The groove 30 extends completely around the boot 12. The height of the groove 30 is determined by the thickness of a panel into which the switch assembly 10 is mounted and in the preferred embodiment is approximately 0.095 inches. Further, FIG. 4 shows a cavity 19 where the wire leads 18, 20 attach to the switch terminals 24, 26. The cavity 19 is filled with an epoxy 16, and the base cover 22 forms the lower surface of the cavity 19. The epoxy 16, which is a two-part, multi-purpose, electrically insulating epoxy, is mixed and applied using a syringe or compressed air dispensing system to fill the cavity and fully seal the switch in the sealing boot 12. The epoxy 16 may be embodied by ARALDITE Part No. 2011 or other equivalent epoxy.

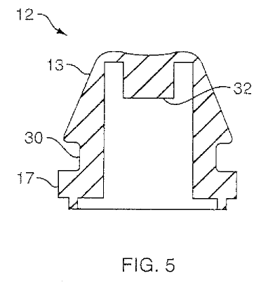

Referring again to FIG. 1 and FIG. 5, the sealing boot 12 is embodied with a neoprene material. FIG. 5 is a cross-sectional view of an upper portion of the sealing boot 12 showing a cylindrical post 32 extending downward from a top inside surface of the sealing boot 12. A button 28 on top of switch 14 protrudes partially into the mushroom-shaped upper section 13 of the boot 12, and the cylindrical post 32, extends downward from the inside top of the mushroom-shaped upper section 13 so that when the top of the boot 12 is pushed in, the cylindrical post 32 contacts the switch button 28 causing it to move and activate the switch 14. A notch 34 (FIG. 1) is provided around the three inside walls of the base section 15 of the boot 12 for receiving the edges of the switch 14 thereby providing a tight fit of the boot 12 around the perimeter of the base of the switch 14.

The single pole double throw pushbutton switch 14 may be embodied by Model No. RP, manufactured by APEM Components, LLC., of Haverhill, Mass. 01835. The base cover 22 fits within the bottom opening of the boot 12 and is secured in place by the epoxy 16 that fills the terminal cavity 19.

A method of assembly of the low cost switch assembly 10 includes the steps of attaching the wire leads 18, 20 to the switch terminals 24, 25 respectively of the pushbutton switch 14, inserting the switch within the boot 12 by hand, placing the base cover in position on the bottom of the sealing boot 12, and filling the terminal cavity 19 with the 2-part epoxy 16 sealant.

It will be apparent that many modifications can be made to the disclosed panel mount, sealed pushbutton switch assembly 10 without departing from the invention. Therefore, it is the intent of the appended claims to cover all such variations and modifications as come within the true spirit and scope of this invention.

What is claimed is:

1. A low cost switch assembly comprising:
a pushbutton switch;
a sealing boot for receiving said pushbutton switch, said sealing boot comprises an upper section for contacting a button portion of said switch and a lower section for receiving a base portion of said switch;
at least two wire leads each attached to a separate terminal of said pushbutton switch; and
a base cover secured to said lower section of said sealing base.

2. The low cost switch assembly as recited in claim 1 wherein said switch assembly comprises a terminal cavity between said terminals of said pushbutton switch, and said base cover, said terminal cavity being filled with an epoxy for sealing said switch assembly.

3. The low cost switch assembly as recited in claim 1 wherein said pushbutton switch comprises a single pole double throw switch.

4. The low cost switch assembly as recited in claim 1 wherein said upper section of said sealing boot comprises a post for contacting said button portion of said pushbutton switch for activating said switch when said upper section of said boot is pushed inward.

5. The low cost switch assembly as recited in claim 1 wherein said sealing boot comprises a groove surrounding an outside of said sealing boot for mounting said switch assembly in an application panel without a tool.

6. A method of making a low cost switch assembly comprising the steps of:
providing a pushbutton switch; and
inserting said pushbutton switch within a sealing boot, wherein a button portion of said switch enters an upper section of said sealing boot and a base portion of said switch is enclosed within a lower section of said sealing boot.
attaching each of at least two lead wires to a separate terminal of said pushbutton switch;
securing a base cover to said lower section of said sealing boot.

7. The method as recited in claim 6 wherein said method comprises the steps of providing a terminal cavity between said terminals of said pushbutton switch and said base cover, and filling said terminal cavity with an epoxy for sealing said switch assembly.

8. The method as recited in claim 6 wherein the step of providing a pushbutton switch comprises the step of providing a single pole double throw pushbutton switch.

9. The method as recited in claim 6 wherein said step of inserting said pushbutton switch within a sealing boot comprises the step of providing a post on the inside of said sealing boot extending toward said button portion of said pushbutton switch to activate said switch when said upper section of said sealing boot is pushed inward.

10. The method as recited in claim 6 wherein said step of inserting said pushbutton switch within a sealing boot comprises the step of providing a groove around an outside perimeter of said sealing boot for mounting said switch assembly in an application panel without use of a tool.
